(19) United States
(12) Patent Application Publication
(10) Pub. No.: US 2007/0244236 A1
(43) Pub. Date: Oct. 18, 2007

(54) Vibration-Damping And Vibration-Isolating Rubber Composition, Method Of Preparation Thereof, And Vibration-Damping And Vibration-Isolating Rubber Products

(75) Inventors: Yasuo Nomura, Kanagawa (JP); Susumu Takahashi, Kanagawa (JP)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: DOW CORNING TORAY CO., LTD., Chiyoda-ku, Tokyo, JP (JP)

(21) Appl. No.: 11/573,609

(22) PCT Filed: Aug. 9, 2003
(86) PCT No.: PCT/JP05/14890

§ 371 Date: Feb. 12, 2007

(30) Foreign Application Priority Data
Aug. 11, 2004 (JP) JP2004-234094
Aug. 11, 2004 (JP) JP2004-234092

(51) Int. Cl. C08K 13/02; C08K 9/06; F16F 1/36

(52) U.S. Cl. 524/262

(57) ABSTRACT

A vibration-damping and vibration-isolating rubber composition comprising: 100 parts by mass of a raw rubber material having C—C bonds in the main chain; 1 to 200 parts by mass of silica; and a silane coupling agent of general formula (1): Y₃—Si-Z-S—CO—R (where Y is an acetoxy or alkoxy group with 1 to 6 carbon atoms, Z is an alkylene group with 1 to 8 carbon atoms, and R is a hydrocarbon group with 1 to 18 carbon atoms) in the amount of 2 to 40 mass % per total amount of the silica.

### TECHNICAL FIELD

The present invention relates to a vibration-damping and vibration-isolating rubber composition, a method of preparation thereof, vibration-damping and vibration-isolating rubber products, and a method of manufacturing of these products.

Background Art

Vibration energy damping technique finds wide application in building and bridge structures, industrial machines, automobiles, electric trains, other means of transportation, etc. In particular, one method for damping vibration energy is the use of products from vibration-damping and vibration-isolating rubber (e.g., for decrease of vibrations and noise transmitted from machine parts and attenuation of shocks transmitted from foundations to building structures).

It is desirable to develop such vibration-damping and vibration-isolating rubber products that will possess good vibration-damping properties (i.e., a low dynamic spring constant [which is also known as dynamic stiffness], good supporting properties, i.e., high static spring constant, and low dynamic multiplication factor, i.e., a ratio of the dynamic spring constant to the static spring constant. Another requirement of vibration-damping and vibration-isolating rubber products is durability under the product operating conditions, e.g., they should have high resistance to ageing, resistance to compression set, etc. As the vibration-damping and vibration-isolating rubber products are obtained in a process that involves forming and then vulcanizing a mixture of a raw rubber material with other compounding agents, the composition should possesses good properties of formability, e.g., molding processability, extruding porcessability, calendaring processability and etc.

Recently, silica is more often included in the compositions of vibration-damping and vibration-isolating rubber products. The vibration-damping and vibration-isolating rubber products that contain silica are well suited for vibration-damping and vibration-isolating applications since they demonstrate improved vibration damping properties and have low dependence of modulus of elasticity on temperature.

At the same time, silica, the surface of which is hydrophilized with silanol groups, reduces wettability of the raw rubber material, and thus impairs its dispersing properties, and imparts high viscosity to the composition that contains such a raw rubber material during and after mixing. Other problems associated with hydrophilized silica are impaired mixing, kneading, and molding properties, e.g., extruding processability, calendaring processability, and etc. Furthermore, the vulcanization accelerator contained in the aforementioned rubber composition is adsorbed on the silica surface, so that eventually the effect of the vulcanization accelerator will disappear.

It was proposed to eliminate the problems inherent in the silica-containing rubber compositions, i.e., compositions for forming a vibration-isolation rubber, by using silica in combination with a polysulfide or a similar silica coupling agent that contains sulfur in its molecule (see Unexamined Patent Application Publication (hereinafter “Kokai”) JP08-059899).

However, even the coexistence of the aforementioned silica coupling agent does not provide sufficient improvement in silica's dispersion. Moreover, the presence in the composition of such a silica coupling agent allows neither sufficient decrease in viscosity, nor sufficient improvement in workability, e.g., suitability for mixing, kneading, and molding. The aforementioned rubber composition can be easily subject to scorching and, hence, to the loss of formability and storage stability. Furthermore, the above composition cannot be formed into a vulcanized rubber with a low dynamic multiplication factor, a low compression set, and a resistance to ageing.

On the other hand, an ethylene-propylene-diene type rubber (EPDM) that possesses high heat-resistant properties is a subject of study for use as a raw rubber material for manufacturing vibration-damping and vibration isolating rubber products operating in a high-temperature environment, e.g., in an engine room, or the like. However, a rubber product (vulcanized rubber) produced from such a raw rubber material as EPDM has a high dynamic multiplication factor that makes this product insufficiently suitable for vibration-damping and vibration-isolating applications and insufficiently durable. In order to solve the above problems by increasing durability and reducing the dynamic multiplication factor of rubber products obtained from the EPDM as a raw rubber material, it was proposed to prepare a rubber composition by compounding the EPDM type raw rubber material with a silica powder having a predetermined BET specific surface area, a sulfur-containing silane coupling agent, and a mercapto-type silane coupling agent (see Kokai JP2003-335907 equivalent to EP 1364989 A).

However, even with introduction of those silane coupling agents, improvement in dispersity of silica is sufficient. The rubber composition disclosed in Kokai JP2003-335907 requires high processing temperature and does not possess sufficient workability because of a high Mooney viscosity. And, the vulcanized rubber obtained from the aforementioned rubber composition does not possess sufficient durability, e.g. a low compression set and high resistance to ageing.

### DISCLOSURE OF INVENTION

It is a first object of the invention to provide a vibration-damping and vibration-isolating rubber composition that is characterized by excellent workability (miscibility, kneadability, and moldability) and storage stability and that can be vulcanized into a vulcanized rubber of excellent vibration-damping and supporting properties with low compression set and high resistance to ageing; and to provide a method for the preparation of the aforementioned composition.

It is a second object of the invention to provide a rubber composition that can be used for forming a vulcanized rubber (vibration-damping and vibration-isolating rubber products) that has a low dynamic multiplication factor, e.g., below 1.40, at vibration-damping and vibration-isolating conditions; and to provide a method for the preparation of the above composition.

It is a third object of the invention to provide vibration-damping and vibration-isolating rubber products that possess excellent vibration-proof and supporting properties, low compression set, and high resistance to ageing; and to provide a method for the preparation of the above products. It is a fourth object of the invention to provide vibration-damping and vibration-isolating rubber products that are characterized by a low dynamic magnification factor, e.g., lower than 1.40; and to provide a method for the preparation of the above products.

As a result of diligent study aimed at achieving the above objects, the inventors herein have found that vibration-damping and vibration-isolating rubber products having good balance between the required properties (i.e., vibration-damping properties, supporting properties, resistance to compression set, resistance to ageing, and general physical properties) can be produced by vulcanizing a rubber composition prepared with excellent formability and storage stability by compounding a silica-containing vibration-damping and vibration-isolating rubber with a specific silane coupling agent having a specific molecular structure and used in a specific amount per total amount of the silica. Thus, the inventors herein arrived at the present invention.

More specifically, the invention provides a vibration-damping and vibration-isolating rubber composition comprising: 100 parts by mass of a raw rubber material having C—C bonds in the main chain; 1 to 200 parts by mass of silica; and a silane coupling agent (hereinafter referred to as a “specific silane coupling agent”) of below-given general formula (1) in the amount of 2 to 40 mass % per total amount of the silica:
Y₃—Si-Z-S—CO—R General formula (1);
(where Y is an acetoxy or alkoxy group with 1 to 6 carbon atoms, Z is an alkylene group with 1 to 8 carbon atoms, and R is a hydrocarbon group with 1 to 18 carbon atoms).

The following are preferred embodiments of the vibration-damping and vibration-isolating composition of the invention:

(1) The aforementioned raw rubber material comprises 20 to 100 parts by mass of a natural rubber and 80 to 0 parts by mass of a synthetic rubber.

(2) The aforementioned raw rubber material comprises 80 to 100 parts by mass of a natural rubber and 20 to 0 parts by mass of a synthetic rubber.

(3) The aforementioned raw rubber material comprises 90 to 100 parts by mass of a natural rubber and 10 to 0 parts by mass of a synthetic rubber.

(4) The aforementioned raw rubber material comprises exclusively a natural rubber.

(5) The aforementioned raw rubber material contains an EPM and/or EPDM at least 30 mass %.

(6) The aforementioned raw rubber material contains an EPM and/or EPDM at least 70 mass %.

(7) The aforementioned raw rubber material contains an EPM and/or EPDM at least 80 mass %.

(8) The aforementioned raw rubber material comprises exclusively an EPM and/or EPDM.

(9) The dynamic multiplication factor obtained after vulcanization does not exceed 1.40.

(10) The dynamic multiplication factor obtained after vulcanization does not exceed 1.38.

(11) The dynamic multiplication factor obtained after vulcanization does not exceed 1.35.

A method for the preparation of the vibration-damping and vibration-isolating rubber composition of the invention consists of mixing and kneading 100 parts by mass of a raw rubber material having C—C bonds in its main molecular chain, 1 to 200 parts by mass of silica, and a specific silica coupling agent in the amount of 2 to 40 mass % per total amount of the aforementioned silica.

The vibration-damping and vibration-isolating rubber products are obtained by vulcanizing the rubber composition of the invention. It is recommended that the vibration-damping and vibration-isolating rubber products have the dynamic multiplication factor below 1.40.

The method of the invention for the preparation of a vibration-damping and vibration-isolating rubber product comprises vulcanization of the rubber composition of the invention.

### EFFECTS OF THE INVENTION

(1) The rubber composition of the invention has low viscosity and is resistant to scorching. Therefore, it demonstrates excellent workability (miscibility, kneadability, and moldability) and storage stability.

(2) Vulcanization of the rubber composition of the invention results in the formation of a vulcanized rubber (vibration-isolating and vibration-isolating rubber products) with excellent vibration-isolating and supporting properties, reduced compression set, and good resistance to ageing.

(3) Vulcanization of the rubber composition of the invention results in the formation of a vulcanized rubber (vibration-damping and vibration-isolating rubber products) with excellent general physical properties (e.g., tensile strength, elongation at rupture, and hardness).

(4) Vulcanization of the rubber composition of the present invention (according to Claim 6) makes it possible to obtain a vulcanized rubber that demonstrates a low (less than 1.40) dynamic multiplication factor in vibration-damping and vibration-isolating applications.

(5) Vibration-damping and vibration-isolating rubber products of the invention possess excellent vibration-damping and supporting properties, low compression set, and good resistance to ageing.

(6) Vibration-damping and vibration-isolating rubber products have adequate general physical properties (tensile strength, elongation at rupture, and hardness).

(7) As the vibration-damping and vibration-isolating rubber products (according to Claim 12) of the invention contain a raw material with EPM and/or EPDM, they have high heat-resistant properties and good balance between such characteristics as vibration-damping properties, supporting properties, compression sets, resistance to ageing, and general physical properties, even when these products are used in a high-temperature environment.

(8) Vibration-damping and vibration-isolating rubber products (according to Claim 13) of the invention have a dynamic multiplication factor below 1.40 in combination with good balance between the excellent vibration-damping properties (a low dynamic spring constant) and excellent supporting properties (a high static spring constant).

### BEST MODE FOR CARRYING OUT THE INVENTION

The invention will be further described in more detail.

[Rubber Composition]

The rubber composition of the invention is a composition for vibration-damping and vibration-isolating applications; more specifically, it is a non-vulcanized rubber composition for forming vibration-damping and vibration-isolating rubber products.

[Raw Rubber Material]

The raw rubber material for the rubber composition of the invention has C—C bonds in its main molecular chain and may constitute a natural (NR) and/or a synthetic rubber. The following are examples of the raw rubber material: natural rubber (NR), styrene butadiene rubber (SBR), isoprene rubber (IR), butadiene rubber (BR), butyl rubber (IIR), halogenated butyl rubber (X-IIR), chloroprene rubber (CR), acrylonitrile butadiene rubber (NBR), a copolymer of ethylene and propylene (EPM), a terpolymer of ethylene, propylene, and a diene (EPDM), etc. These raw rubber materials can be used individually or as a blend of two or more types. Most preferable of the above are natural rubber (NR), isoprene rubber (IR), butadiene rubber (BR), styrene butadiene rubber (SBR), a copolymer of ethylene and propylene (EPM), and a terpolymer of ethylene, propylene, and a diene (EPDM).

Molecular terminals of these raw rubber materials can be modified with a metal or an organic substance. For example, in the case of a butadiene rubber, the molecular terminals thereof can be modified with a modifying agent, such as a metal salt, e.g., tin tetrachloride, or an organic group such as a lactam compound.

A styrene butadiene rubber (SBR) suitable for the invention may comprise both solution-polymerization SBR (S-SBR) and emulsification-polymerization SBR (E-SBR), or a high-styrene rubber with the styrene content exceeding 60 mass %.

There are no special restrictions with regard to proportions of the ethylene and propylene in the EPM and of the ethylene, propylene, and diene in the EPDM. The appropriate proportion is selected so as to obtain desired final properties in the rubber composition and in the rubber product. The following are specific examples of dienes that are used in the EPDM's: 1,4-pentadiene, 1,4-hexadiene, 1,5-hexadiene, 2,5-dimethyl-1,5-hexadiene, 1,4-octadiene, 1,4-cyclohexadiene, cyclooctadiene, dicyclopentadiene, 5-ethylidene-2-norbornene, 5-butylidene-2-norbornene, 2-methallyl-5-norbornene and 2-isopropenyl-5-norbornene, etc. These dienes can be used individually or in combinations of two or more.

Among the raw material rubbers for the composition of the invention, it is recommended to use those that contain more than 20 mass %, preferably more than 80 mass %, even more preferably, more than 90 mass %, and most preferably, 100 mass % of the natural rubber (NR). In a vulcanized rubber (vibration-damping and vibration-isolating products) obtained from the aforementioned rubber composition, an increase in the contents of the natural rubber (NR) decreases the dynamic multiplication factor and compression set. The following are preferable examples of raw rubber materials that can be used in combination with the natural rubber (NR); isoprene rubber (IR), butadiene rubber (BR), styrene butadiene rubber (SBR), and EPM and/or EPDM. These raw rubber materials can be used in combination with the natural rubber (NR) or as a blend of two or more types.

Furthermore, among the raw rubber materials, it is also recommended to use those that contain more than 30 mass %, preferably more that 70 mass %, even more preferably, more than 80 mass %, and most preferably, 100 mass % of the EPM and/or EPDM. The higher is the content of the EPM and/or EPDM, the better is the thermal stability (resistance to ageing) in the obtained vulcanized rubber (vibration-damping and vibration-isolating rubber product) produced from the rubber composition.

The use of raw rubber materials in combination with the EPM and/or EPDM makes it possible to obtain a vulcanized rubber (a vibration-damping and vibration-isolating rubber product) with a reduced dynamic multiplication factor (see below-given Practical Examples 8 and 9). The following are preferable examples of raw rubber materials that can be used in combination with the EPM and/or EPDM: natural rubber (NR), isoprene rubber (IR), butadiene rubber (BR), and styrene butadiene rubber (SBR). These raw rubber materials can be used individually or as a blend of two or more types.

[Silica]

There are no special restrictions with regard to the silica used in the composition of the present invention. This can be any conventionally used silica, such as a fumed silica, precipitated silica, fused silica, crystalline silica, spherical silica, crushed silica, etc. Furthermore, this may be a moisture-containing or dehydrated silica, but the moisture-containing silica is preferable. The silica should have a specific surface-area within the range of 5 to 400 m²/g, preferably, 10 to 300 m²/g. and even more preferably, 50 to 300 m²/g. The specific surface area of the silica can be measured by a nitrogen adsorption method (e.g., with the use of a surface-area measuring device, model SA-1000 produced by Shibata Kagakukikai Kogyo Co., Ltd.).

The silica should be added to the rubber composition of the invention in an amount of 1 to 200 parts by mass (phr), preferably 2 to 150 parts by mass (phr), and even more preferably, 5 to 100 parts by mass (phr), and the most preferably, 10 to 100 parts by mass (phr) per 100 parts by mass of the raw rubber material.

[Specific Silane Coupling Agent]

The specific silane coupling agent contained in the rubber composition of the invention is expressed by below-given general formula (1): Y₃—Si-Z-S—CO—R

(where Y is an acetoxy group or an alkoxy group with 1 to 6 carbon atoms, Z is an alkylene group with 1 to 8 carbon atoms, and R is a hydrocarbon group with 1 to 18 carbon atoms).

The acetoxy or alkoxy group with 1 to 6 carbon atoms designated in formula (1) by Y may be exemplified by methoxy, ethoxy, propoxy, isopropoxy, isobutoxy, or a similar alkoxy group; acetoxy group, etc. Of these, most preferable is an alkoxy group with 1 to 4 carbon atoms. The alkylene group with 1 to 8 carbon atoms designated in formula (1) by Z, may be exemplified by a methylene group (—CH₂—), ethylene group (—CH₂CH₂—), trimethylene group (—CH₂CH₂CH₂—), tetramethylene group (—CH₂CH₂CH₂CH₂—), propylene group (—CH(CH₃)CH₂—), etc. Of these, most preferable are the ethylene group and propylene group.

The hydrocarbon group with 1 to 18 carbon atoms designated in formula (1) by R may comprise a linear-chained, cyclic, or branch-chained alkyl group, alkenyl group, aryl group, or aralkyl group. Specific examples are the following: methyl, ethyl, propyl, isopropyl, butyl, isobutyl, t-butyl, pentyl, isopentyl, hexyl, isohexyl, heptyl, isoheptyl, octyl, isooctyl, nonyl, isononyl, decyl, isodecyl, undecyl, isoundecyl, dodecyl, isododecyl, tridecyl, isotridecyl, tetradecyl, isotetradecyl, pentadecyl, isopentadecyl, hexadecyl, isohexadecyl, heptadecyl, isoheptadecyl, octadecyl, isooctadecyl group, etc.

The following are examples of the specific silica coupling agent: 3-triethoxysilylpropyl thioacetate, 3-trimethoxysilylpropyl thioacetate, 3-octanoylthiopropyl trimethoxysilane, 3-octanoylthiopropyl trimethoxysilane, 3-octanoylthiopropyl tripropoxysilane, 2-acetylthioethyl trimethoxysilane, etc. Most preferable is the 3-octanoylthiopropyl trimethoxysilane.

The specific silanol coupling agent can be produced by a known process, e.g., by an ester-exchange reaction between an appropriate mercaptotrialkoxysilane and a thioester (see WO 99/09036). The 3-octanoylthiopropyl trimethoxysilane as the most suitable specific silane coupling agent can be obtained commercially as “NXT Silane” produced by Nippon Unicar Co., Ltd.

In the rubber composition of the invention, the specific silanol coupling agent may be used in an amount of 2 to 40 mass % per total content of the silica [i.e., in the amount of 0.02 w to 0.40 w (phr), if amount of the silica is represented in w (phr) units], preferably 2 to 30 mass %, and even more preferably, 5 to 20 mass %. If the content of the specific silanol coupling is less than 2 mass % per total mass of the silica, the effect provided by the addition of the silica coupling agent will not be achieved. If, on the other hand, the amount of the added specific silica coupling agent exceeds 40 mass %, this will not improve the effect, but, on the contrary, will delay vulcanization of the obtained rubber composition and will be economically unjustifiable in view of a relatively high cost of this agent in comparison to other components.

[Arbitrary Components]

Within the limits not contradictory to the effect of the invention, the composition may be compounded with various additional components. Such additional components may be comprise reinforcing agents (except for silica), fillers, vulcanization agents, vulcanization accelerators, vulcanization assisting agents, vulcanization retarders (scorch retarders), anti-ageing agents, softeners, silane coupling agents (except for the aforementioned specific silane coupling agent), plasticizers, stabilizers, workability improvers, coloring agents, etc.

Reinforcing agents as arbitrary components for the composition can be represented by carbon black, calcium carbonate, talc, etc. The carbon black is preferable. The presence of the reinforcing agent improves supporting properties of the rubber products (vulcanized rubber). The reinforcing agents as arbitrary components should be used in an amount of 0 to 100 parts by mass per 100 parts by mass of the raw rubber material.

The filler material as an arbitrary additive may be represented by phenol resins, polyamide resins, high-styrene resins, or other resins; short fibers of different types, etc.

The vulcanization agent as an arbitrary additive may be represented by sulfur-type vulcanization agents, peroxide-type vulcanization agents, and oxime-type vulcanization agent.

The sulfur-type vulcanization agent may be exemplified by sulfur, insoluble sulfir, tetramethylthiuram disulfide, morpholine disulfide, etc. Most preferable is sulfur that can be added in the amount of 0.5 to 5 parts by mass per 100 parts by mass of the raw rubber material.

The peroxide-type vulcanization agent can be exemplified by dicumyl peroxide, n-butyl-4,4-bis(t-butylperoxy)valerate, t-butylcumyl peroxide, di-t-butylperoxy-diisopropyl benzene, or other peroxides.

The peroxide-type vulcanization agent should be used in amounts adjusted in accordance with the amounts of the EPM and/or EPDM used in the composition.

The oxime type vulcanization agent can be represented by p-quinone dioxime, p,p′-dibenzoylquinone dioxime, etc.

The vulcanization accelerating agent as an arbitrary additive improves effect of cross-linking (i.e., rate of vulcanization) by combining with an aforementioned vulcanization agent. The vulcanization accelerating agent can be represented by sulfenamide-type compounds, thiazole-type compounds, guanidine-type compounds, aldehyde-amine or aldehyde-ammonia type compounds, thiourea-type compounds, thiuram-type compounds, dithiocarbamic acid salts, xanthate-type compounds, etc. The vulcanization accelerating agent can be added in the amount of 0.5 to 5 parts by mass per 100 parts by mass of the raw rubber material.

The sulfenamide-type compound as a vulcanization accelerating agent can be exemplified, e.g., by N-cyclohexyl-2-benzothiazol sulfenamide, N-oxydiethylene-2-benzothiazol sulfenamide, N,N-diisopropyl-2-benzothiazol sulfenamide, etc.

The thiazol-type compounds can be exemplified, e.g., by 2-mercaptobenzothiazol, 2-(2,4-dinitrophenyl) mercaptobenzothiazol, 2-(2,6-diethyl-4-morpholinothio) benzothiazol, dibenzothiazyl disulfide, etc.

The guanidine-type compounds can be represented, e.g., by diphenyl guanidine, diorthotolyl guanidine, triphenyl guanidine, orthotolyl biguanide, diphenyl guanidinephthalate, etc.

The aldehyde-amine or aldehyde-ammonia type compounds can be exemplified, e.g., by acetoaldehyde-aniline reaction products, butylaldehyde-aniline condensation products, hexamethylene tetramine, and acetoaldehyde-ammonia reaction products, etc.

The thiourea compounds can be exemplified, e.g., by 2-mercaptoimidazoline, or similar imidazoline-type compounds, thiacarbamide, diethylthiourea, dibutylthiourea, trimethylthiourea, diorthotolylthiourea, etc.

The thiuram-type compounds may be represented, e.g., by tetramethylthiuram monosulfide, tetramethylthiuram disulfide, tetraethylthiuram disulfide, tetrabutylthiuram disulfide, pentamethylenethiuram tetrasulfide, etc.

The dithiocarbamic acid salts can be exemplifies by zinc dimethyldithiocarbamate, zinc diethyldithiocarbamate, zinc ethylphenyldithiocarbamate, zinc butylphenyl dithiocarbamate, sodium dithiocarbamate, selenium dimethyldithiocarbamate, tellurium diethyldithiocarbamate, etc.

The xanthate-type compounds can be represented, e.g., by zinc dibutyl xanthogenate.

The vulcanization assistant agents as arbitrary additives to the rubber composition of the invention may be exemplified by known compounds, e.g., metal oxides, such as zinc oxide; aliphatic acids, such as stearic acid; and amine-type compounds, such as di-n-butylamine.

The vulcanization retarders (scorch retarders) as arbitrary additives to the rubber composition of the invention may be exemplified by an anhydrous phthalic acid, N-cyclohexylthiophthalimide, etc.

The anti-ageing agents as arbitrary additives to the rubber composition of the invention may be exemplified by amine-ketone type, aromatic secondary amine type, monophenol-type, bisphenol-type, polyphenol-type, benzoimidazole-type, dithiocarbamic acid salt type, thiourea type, phosphorous-acid type, organic thio acid type, specific wax type compounds, and mixtures of the aforementioned anti-ageing agents.

The softeners as arbitrary additives to the rubber composition of the invention may be exemplified by petroleum-type softeners (e.g., Process oil, lubricating oil, paraffin, liquid paraffin, Vaseline, etc.), aliphatic-type softeners (e.g., castor oil, linseed oil, rapeseed oil, coconut oil, etc.), waxes (e.g. tall oil, factice, beeswax, carnauba wax, lanoline, etc.), linolic acid, palmitic acid, stearic acid, lauric acid, etc. The softener can be added in the amount of 1 to 200 parts, preferably, 1 to 100 parts by mass per 100 parts by mass of the raw rubber material.

The silane coupling agent (except for the aforementioned specific silane coupling agent) as arbitrary additives to the rubber composition of the invention may be exemplified by a mercaptopropyltrialkoxysilane, bistrimethyl silylpolysulfide, etc.

All aforementioned arbitrary components can be mixed and kneaded together with the indispensable components, or, if necessary, the indispensable components can be mixed with a part of the arbitrary components, and the remaining part can be added for mixing and kneading prior to vulcanization.

### THE METHOD OF PREPARATION OF THE COMPOSITION OF THE INVENTION

The composition preparation method of the invention comprises the step of mixing and kneading the raw rubber material with the silica and the specific silica coupling agent. If necessary, mixing and kneading can be carried out after premixing the raw rubber material with the arbitrary components. Mixing and kneading can be carried out in a Banbury mixer, kneader, two-roll-mill, etc.

One example of the composition preparation method is described below.

(1) The raw rubber material, silica, specific silica coupling agent, and arbitrary components (except for the vulcanization agent and vulcanization accelerator) are mixed and kneaded in a sealed mixer, such as a Banbury mixer, whereby a non-vulcanized rubber composition is obtained. Mixing and kneading conditions (e.g., temperature and time) may differ with the kind of mixer. For example, when a 5-liter capacity Banbury mixer is used, the process may be carried out for 1 to 60 min. at a temperature within the range of 80 to 170° C. If the raw rubber material contains NR, preferably, the process can be carried out within the range of 80 to 150° C. to avoid decomposing the NR. Since the obtained rubber composition is free of vulcanization components, the composition may be stored as it is for a predetermined period of time.

(2) The composition obtained in Item (1) may be compounded with a vulcanization agent and mixed and kneaded for the second time to obtain a rubber composition that contains a vulcanization system. At this stage, mixing and kneading can be carried out for 5 to 60 min. at 40 to 70° C.

The obtained composition is preformed into a predetermined shape, e.g., into a sheet. This can be done with the use of a forming machine such as an extruder, calender, two-roll-mill, press, etc. In the case of a two-roll-mill, kneading and preforming (forming into a sheet) can be combined into a single operation.

### PRODUCT MANUFACTURING METHOD OF THE INVENTION

The product manufacturing method of the invention comprises the step of vulcanization of the rubber composition of the invention, whereby the composition is formed into a vibration-damping and vibration-isolating rubber product of the invention. Conditions for vulcanization of the composition (i.e., temperature and time) may constitute 100 to 270° C. and 1 to 150 min., respectively. Vulcanization can be carried out in a metal mold or without the mold. If not using a metal mold or using a transfer-molding equipment, the forming and vulcanization can be carried out in a continuous mode. An example of a manufacturing process is feeding the rubber composition, preformed into a sheet, to a press-type vulcanization apparatus, and heating it for 1 to 150 min. at a temperature of 100 to 270° C. and at a pressure of 2 to 50 MPa. Such a treatment will result in a vibration-damping and vibration-isolating rubber product of a predetermined shape.

### VIBRATION DAMPING AND VIBRATION-ISOLATING RUBBER PRODUCTS OF THE INVENTION

The vibration damping and vibration-isolating rubber products of the invention are obtained by vulcanizing the rubber composition of the invention. In addition to the vulcanized rubber obtained only from the composition of the invention, the vibration-damping and vibration-isolating rubber products of the invention may also be formed into composite products that comprise a vulcanized rubber in combination with other materials (e.g., metal).

The vibration damping and vibration-isolating rubber products (vulcanized rubber) of the invention should have the dynamic multiplication factor (i.e., a ratio of the dynamic spring constant to the static spring constant) that satisfies requirements of vibration damping and vibration-isolating applications. It is recommended to have this factor below 1.40, preferably below 1.38, and even more preferably, below 1.35. Such a low dynamic multiplication factor can be achieved by increasing the percentage of natural rubber (NR) contained in the raw rubber material.

When the vibration damping and vibration-isolating rubber products (vulcanized rubber) of the invention contains the raw rubber material with the EPM and/or the EPDM, it has not only a low dynamic multiplication factor (the ratio of the dynamic spring constant to the static spring constant) and a good balance between excellent vibration-damping and supporting properties but also high resistance to heat and maintain good balance between the appropriate properties (e.g., vibration-damping properties, low post-compression residual deformation, anti-ageing properties, and general physical properties) even when used in a high-temperature environment (e.g., at temperatures above 140° C.). Such a low dynamic multiplication factor is obtained by specifying proportions of the silica relative to the raw rubber materials and proportions of the specific silane coupling agent relative to the used silica, thus improving dispersion of the silica in the obtained rubber composition.

### PRACTICAL EXAMPLES

The invention will be further described in more detail with reference to practical examples. However, these examples should not be construed as limiting the scope of the invention.

### Practical Example 1

A 1.7-liter Banbury mixer (Kobe Steel Co., Ltd.) was loaded with 100 parts by mass of the natural rubber (RSS-No. 1). After kneading for 30 sec., the rubber was combined, in accordance with the data of Table 1, with 20 parts by mass of silica (precipitated silica; “Nipsil ER”, the product of Tosoh Silica Corporation, specific surface area=100 m²/g), 3 parts by mass of the specific silica coupling agent in the form of 3-octanoylthiopropyl trimethoxysilane “NXT Silane” (the product of Nippon Unicar Co.), 5 parts by mass of the petroleum type softener (Diana Process Oil NM-280, the product of Idemitsu Kosan Co., Ltd.), 5 parts by mass of zinc oxide (Zinc White Type 1), 1 part by mass of a stearic acid, and 1 part by mass of an anti-ageing agent in the form of 2,2′-methylene-bis(4-ethyl-6-butylphenol) (Nonflex EBP, the product of Seiko Kagaku Co., Ltd.). The components were mixed and kneaded. The obtained rubber composition of the invention was discharged (discharge temperature=165° C.).

The obtained composition was cooled to about 60° C. and then was combined with 2.5 parts by mass of sulfur, 1.0 part by mass of the vulcanization accelerator “Nocceler-CZG” (N-cyclohexyl-2-benzothiazol sulfenamide, the product of Ouchishinko Chemical Industrial Co., Ltd.), and 0.2 parts by mass of the vulcanization accelerator “Nocceler-D”) (1,3-diphenyl guanidine, the product of Ouchishinko Chemical Industrial Co., Ltd.). The mixture was kneaded and formed into a sheet-like rubber preform by means of a two-roll-mill (steam-heated 6-inch roller with 55° C. roller temperature).

The obtained sheet-like rubber preform was subjected to press vulcanization for 30 min. at 150° C. and formed into a 2 mm-thick vulcanized rubber sheet (a vibration-damping and vibration-isolating rubber product of the invention).

An 8 mm-thick vulcanized rubber sheet was produced under the same press-vulcanization conditions (for hardness-measuring purposes).

Another specimen (29 mm diameter×12.5 mm thickness) was produced under the same press-vulcanization conditions for measuring compression set.

Still another specimen (50 mm diameter×25 mm thickness) was produced under the same press-vulcanization conditions for measuring the dynamic and static spring constants.

### Practical Example 2

A rubber composition of the invention was prepared in the same manner as in Practical Example 1, except that, in accordance with the data of Table 1, the raw rubber material comprised a rubber blend composed of 90 parts by mass of a natural rubber and 10 parts by mass of a butadiene rubber “BRO 1” (the product of JSR Co., Ltd.). This composition was used for preparing vibration-damping and vibration-isolating rubber products (vulcanized rubber sheets and specimens) of the invention.

### Practical Example 3

A rubber composition of the invention was prepared in the same manner as in Practical Example 1, except that, in accordance with the data of Table 1, the raw rubber material comprised a rubber blend composed of 60 parts by mass of a natural rubber and 40 parts by mass of a butadiene rubber “BR01” (the product of JSR Co., Ltd.). This composition was used for preparing vibration-damping and vibration-isolating rubber products (vulcanized rubber sheets and specimens) of the invention.

### Practical Example 4

A rubber composition of the invention was prepared in the same manner as in Practical Example 1, except that, in accordance with the data of Table 1, the raw rubber material comprised a rubber blend composed of 80 parts by mass of a natural rubber and 20 parts by mass of a butadiene rubber “JSR1500” (the product of JSR Co., Ltd.). This composition was used for preparing vibration-damping and vibration-isolating rubber products (vulcanized rubber sheets and specimens) of the invention.

### Practical Example 5

A rubber composition of the invention was prepared in the same manner as in Practical Example 1, except that, in accordance with the data of Table 1, the amount of the silica was changed for 40 parts by mass, the amount of the specific silica coupling agent was changed for 6 parts by mass, and the amount of the petroleum-type softener was changed for 15 parts by mass. This composition was used for preparing vibration-damping and vibration-isolating rubber products (vulcanized rubber sheets and specimens) of the invention.

### Comparative Example 1

A comparative rubber composition was prepared in the same manner as in Practical Example 1, except that, in accordance with the data of Table 1, the silica was replaced by 30 parts by mass of FEF carbon black (SEAST-166”; the product of Tokai Carbon Co., Ltd.), and the specific silica coupling agent was not used at all. This comparative composition was used for preparing vibration-damping and vibration-isolating rubber products (vulcanized rubber sheets and specimens) of the invention.

### Comparative Example 2

A comparative rubber composition was prepared in the same manner as in Practical Example 1, except that the specific silica coupling agent was replaced with 2 parts by mass of a bis-triethoxysilylpropyl polysulfide silica coupling agent “A-1589” (the product of Nippon Unicar Co., Ltd.) with an average sulfur number in the sulfur chain equal to 2. This comparative composition was used for preparing vibration-damping and vibration-isolating rubber products (vulcanized rubber sheets and specimens) of the invention.

[Workability and Storage Stability]

(1) Mooney Viscosity

The Mooney viscosity (125° C.) of all rubber compositions obtained in Practical Example 1 to 5 and Comparative Examples 1 and 2 was measured in accordance with JIS K 6300. The results of measurements are shown in Table 1 as an exponential factor referenced to the viscosity of the rubber composition of Comparative Example 1 as 100.

(2) Mooney Scorch Time

The Mooney scorch time (125° C.) of all rubber compositions obtained in Practical Example 1 to 5 and Comparative Examples 1 and 2 was measured in accordance with JIS K 6300. The results of measurements are shown in Table 1 as an exponential factor referenced to the viscosity of the rubber composition of Comparative Example 1 as 100.

(3) Tensile Strength and Elongation (General Physical Properties)

Specimens (dumbbell specimens #3) were produced from all 2 mm-thick vulcanized rubber sheets obtained in Practical Examples 1 to 5 and Comparative Examples 1 and 2. Tensile strength (T_{B}) and elongation (E_{B}) were measured in accordance with JIS K6251 at 25° C. and with a stretching speed of 500 mm/min. The results are shown in Table 1.

(4) Hardness

Hardness was measured on all 8 mm-thick vulcanized rubber sheets obtained in Practical Examples 1 to 5 and Comparative Examples 1 and 2 in accordance with JIS K 6253 (hardness by a JIS type-A hardness tester). The results of measurements are shown in Table 1.

(5) Static Spring Constant

Specimens (50 mm diameter×25 mm thickness) obtained in Practical Examples 1 to 5 and Comparative Examples 1 and 2 were used for measuring the static spring constant in accordance with JIS K6385. More specifically, each specimen was compressed by 7 mm by a load applied in the axial direction of a cylinder, the load was reduced, and after the specimen restored its shape, it was compressed by 7 mm by a load for the second time for subsequent calculation of the static spring constant (Ks). The results are shown in Table 1.

(6) Dynamic Spring Constant

Specimens (50 mm diameter×25 mm thickness) obtained in Practical Examples 1 to 5 and Comparative Examples 1 and 2 were used for measuring the dynamic spring constant in accordance with JIS K6385. More specifically, each specimen was compressed by 2.5 mm in the axial direction of a cylinder, and permanent-displacement harmonic compressive vibrations having the frequency of 100 Hz and amplitude of ±0.05 mm were applied from below the specimen to its center for determining 100 Hz dynamic spring constant (Kd₁₀₀). The results are shown in Table 1.

(7) Dynamic Multiplication Factor

The dynamic multiplication factor (the ratio of the dynamic spring constant to the static spring constant) was determined from the value of the dynamic spring constant (Kd₁₀₀) and the static spring constant (Ks) measured on the specimens obtained in Practical Examples 1 to 5 and Comparative Examples 1 and 2. The results are shown in Table 1.

(8) Compression Set

The compression set was measured on all specimens (diameter 29 mm×thickness 12.5 mm) obtained in Practical Examples 1 to 5 and Comparative Examples 1 and 2 in accordance with JIS K6262 and at the following conditions: temperature=100° C.; compression degree=25%; compression time=22 hours; and room-temperature relaxation time after compression=30 min. The results are shown in Table 1.

(9) Resistance to Ageing (Compression Set after Ageing)

This property was determined by measuring the compression set by the same method as in Item (8) above, but after the specimens obtained in Practical Examples 1 to 5 and Comparative Examples 1 and 2 (diameter 29 mm×thickness 12.5 mm) acquired heating hysteresis by heating for 300 hours at 100° C. in an oven and being held in a relaxation state at room temperature for 24 hours. The compression set was also measured on specimens obtained in Practical Examples 1 (diameter 29 mm×thickness 12.5 mm) acquired heating hysteresis by heating for 24 hours at 150° C. in an oven and being held in a relaxation state at room temperature for 24 hours. The results are shown in Table 1.

TABLE 1

| | Practical | Practical | Practical | Practical | Practical | Comp. | Comp. |
|---|---|---|---|---|---|---|---|
| | Example | Example | Example | Example | Example | Example | Example |
| | 1 | 2 | 3 | 4 | 5 | 1 | 2 |
| NR: “RSS-1” | 100 | 90 | 60 | 80 | 100 | 100 | 100 |
| BR¹⁾ | — | 10 | 40 | — | — | — | — |
| SBR²⁾ | — | — | — | 20 | — | — | — |
| Silica³⁾ | 20 | 20 | 20 | 20 | 40 | — | 20 |
| FEF Carbon Black⁴⁾ | — | — | — | — | — | 30 | — |
| Specific Silane | 3 | 3 | 3 | 3 | 6 | — | — |
| Coupling Agents⁵⁾ | | | | | | | |
| Silane Coupling | — | — | — | — | — | — | 2 |
| Agent⁶⁾ | | | | | | | |
| Softener: “NM-280”⁷⁾ | 5 | 5 | 5 | 5 | 15 | 5 | 5 |
| Zinc White Type1 | 5 | 5 | 5 | 5 | 5 | 5 | 5 |
| Stearic Acid | 1 | 1 | 1 | 1 | 1 | 1 | 1 |
| Anti-Aging Agents⁸⁾ | 1 | 1 | 1 | 1 | 1 | 1 | 1 |
| Sulfur | 2.5 | 2.5 | 2.5 | 2.5 | 2.5 | 2.5 | 2.5 |
| (Vulcanization Agent) | | | | | | | |
| CBS⁹⁾ | 1 | 1 | 1 | 1 | 1 | 1 | 1 |
| DPG¹⁰ | 0.2 | 0.2 | 0.2 | 0.2 | 0.2 | 0.2 | 0.2 |
| Mooney Viscosity | 115 | 117 | 130 | 108 | 120 | 100 | 135 |
| [index number] | | | | | | | |
| Mooney Scorch Time | 112 | 108 | 101 | 113 | 110 | 100 | 105 |
| [index number] | | | | | | | |
| Tensile Strength (T_{B}) | 21.5 | 20.1 | 19.8 | 21.0 | 17.8 | 24.8 | 22.8 |
| [MPa] | | | | | | | |
| Elongation (E_{B}) [%] | 470 | 430 | 410 | 470 | 430 | 600 | 480 |
| Hardness | | | | | | | |
| [JIS Type A] | 56 | 56 | 55 | 57 | 58 | 54 | 56 |
| Static Spring | 433 | 422 | 416 | 415 | 491 | 390 | 412 |
| Constant (Ks) | | | | | | | |
| [N/mm] | | | | | | | |
| Dynamic Spring | | | | | | | |
| Constant (Kd₁₀₀) | 580 | 582 | 587 | 554 | 648 | 578 | 590 |
| [N/mm] | | | | | | | |
| Dynamic | 1.34 | 1.38 | 1.41 | 1.33 | 1.32 | 1.48 | 1.43 |
| Multiplication Factor | | | | | | | |
| Compression Set [%] | 34 | 36 | 49 | 35 | 39 | 37 | 46 |
| Compression Set [%] | 40 | 44 | 52 | 43 | 47 | 50 | 59 |
| after 100° C./300h | | | | | | | |
| ageing | | | | | | | |
| Compression Set [%] | | | | | | | |
| after 150° C./24h | 78 | — | — | — | — | — | — |
| ageing | | | | | | | |

¹⁾“BR01” (JSR Co., Ltd.)
²⁾“JSR 1500” (JSR Co., Ltd.)
³⁾“Nipsil ER” (Tosoh Silica Corporation)
⁴⁾“SEAST-166” (the product of Tokai Carbon Co., Ltd.)
⁵⁾“NXT Silane” (the product of Nippon Unicar Co., Ltd.)
⁶⁾bis-triethoxysilylpropyl polysulfide “A-1589” (the product of Nippon Unicar Co., Ltd.)
⁷⁾“Diana Process Oil NM-280”, (the product of Idemitsu Kosan Co., Ltd.)
⁸⁾2,2′-methylene-bis(4-ethyl-6-butylphenol) (Nonflex EBP, the product of Seiko Kagaku Co., Ltd.)
⁹⁾N-cyclohexyl-2-benzothiazol sulfonamide “Nocceler-CZG” (the product of Ouchishinko Chemical Industrial Co., Ltd.
¹⁰⁾1,3-diphenyl guanidine “Nocceler-D” (the product of Ouchishinko Chemical Industrial Co., Ltd.).

The following conclusions can be made by analyzing the results shown in Table 1.

(1) The rubber compositions obtained in Practical Examples 1 to 5 demonstrate low Mooney viscosity, are characterized by long Mooney scorch time, resist to scorching, and possess excellent formability and storage stability.

(2) The vulcanized rubbers obtained in Practical Examples 1 to 5, in particular, in Practical Examples 1, 2 and Practical Examples 4, 5, have low dynamic multiplication factors and are suitable for vibration-damping and vibration-isolating applications.

(3) The vulcanized rubbers obtained in Practical Examples 1 to 5, in particular, in Practical Examples 1, 2 and Practical Examples 4, 5, have low compression set (compression-caused permanent deformation prior to and after ageing); therefore, the rubber products produced from such rubbers demonstrate high endurance.

(4) By increasing the percentage of natural rubber in the raw rubber material, it becomes possible to reduce the Mooney viscosity and extend the Mooney scorching time (results of the rubber compositions obtained in Practical Examples 1 to 3).

(5) By increasing the percentage of natural rubber in the raw rubber material, it becomes possible to improve general physical properties, increase the static spring constant, reduce the dynamic multiplication factor, and reduce compression set (compression-caused permanent deformation prior to and after ageing) (results of the rubber compositions obtained in Practical Examples 1 to 3).

(6) The rubber composition of Practical Example 1 that is compounded with the “NXT Silane” has lower Mooney viscosity and longer Mooney scorching time than the rubber composition of Comparative Example 2 compounded with “A-1589”.

(7) The vulcanized rubber of Practical Example 1 has lower dynamic multiplication factor than the vulcanized rubber of Comparative Example 2.

(8) The vulcanized rubber of Practical Example 1 has lower compression set (i.e., compression-caused permanent deformation prior to and after ageing) than the vulcanized rubber of Comparative Example 2.

### Practical Example 6

In accordance with the data of Table 2, a 1.7-liter Banbury mixer (Kobe Steel Co., Ltd.) was loaded with 175 parts by mass of EP98 (an oil-extended EPDM, the product of JSR Co., Ltd.; oil constituent=75 phr) (100 parts by mass of EPDM), 20 parts by mass of silica (Nipsil ER, the product of Tosoh Silica Corporation, specific surface area=100 m²/g), 3 parts by mass of the specific silane coupling agent in the form of 3-octanoylthiopropyl trimethoxysilane “NXT Silane” (the product of Nippon Unicar Co.; silica content was 15 mass %), 5 parts by mass of the petroleum type softener (Diana Process Oil PW-380, the product of Idemitsu Kosan Co., Ltd.), 5 parts by mass of zinc oxide (Zinc White Type 1), 1 part by mass of a stearic acid, and 1 part by mass of an anti-ageing agent in the form of 2,2′-methylene-bis(4-ethyl-6-butylphenol) (Nonflex EBP, the product of Seiko Kagaku Co., Ltd.). The components were mixed and kneaded. The obtained rubber composition of the invention was discharged (discharge temperature=170° C.).

The obtained composition was cooled to about 60° C. and then was combined with 2.0 parts by mass of sulfur, 1.0 part by mass of a vulcanization accelerator “Nocceler-M-P” (the product of Ouchishinko Chemical Industrial Co., Ltd.) composed of MBT (2-mercaptobenzothiazol), 1.5 parts by mass of a vulcanization accelerator (“Nocceler-CZ-G”) (the product of Ouchishinko Chemical Industrial Co., Ltd.) composed of CBS (N-cyclohexyl-2-benzothiazol-sulfenamide), 0.7 parts by mass of a vulcanization accelerator (“Nocceler-TT-P”) (the product of Ouchishinko Chemical Industrial Co., Ltd.) composed of TMTD (tetramethylthiuram disulfide), 0.5 parts by mass of a vulcanization accelerator (“Nocceler-TRA”) (the product of Ouchishinko Chemical Industrial Co., Ltd.) composed of DPTT (dipentamethylenethiuram tetrasulfide), and 0.5 parts by mass of a vulcanization accelerator (“Nocceler-TTTE”) (the product of Ouchishinko Chemical Industrial Co., Ltd.) composed of TeEDC (diethyl dithiocarbamic acid tellurium). The mixture was kneaded and formed into a sheet-like rubber preform by means of a two-roll-mill (steam-heated 6-inch roller with 55° C. roller temperature).

The obtained sheet-like rubber preform was subjected to press vulcanization for 30 min. at 170° C. and formed into a 2 mm-thick vulcanized rubber sheet (a vibration-damping and vibration-isolating rubber product of the invention).

An 8 mm-thick vulcanized rubber sheet was produced under the same press-vulcanization conditions (for hardness-measuring purposes).

Another specimen (29 mm diameter×12.5 mm thickness) was produced under the same press-vulcanization conditions for measuring compression set.

Still another specimen (50 mm diameter×25 mm thickness) was produced under the same press-vulcanization conditions for measuring the dynamic and static spring constants.

### Practical Example 7

A rubber composition of the invention was prepared by mixing and kneading the components in the same manner as in Practical Example 6, except that, in accordance with the data of Table 2, the raw rubber material comprised a rubber blend composed of 140 parts by mass of EPDM [EP98] (the product of JSR Co., Ltd.) and 20 parts by mass of EPM [EP11] (the product of JSR Co., Ltd.), the amount of silica was changed to 40 parts by mass, and the amount of the specific silane coupling agent was changed to 6 parts by mass.

The obtained composition was cooled to about 60° C. and then was combined with 2.5 parts by mass of a vulcanization accelerator “VULNOC GM-P” (the product of Ouchishinko Chemical Industrial Co., Ltd.) composed of p-quinone dioxime and 8.0 parts by mass of a vulcanization accelerator PERCUMYL D-40 (the product of Nippon Oils and Fats Co., Ltd.) composed of dicumyl peroxide. The mixture was kneaded and formed into a sheet-like rubber preform (the rubber composition of the invention that contained a vulcanization system) by means of a roller machine (steam-heated 6-inch roller with 55° C. roller temperature).

The vibration-damping and vibration-isolating products (vulcanized rubber sheets and specimens) of the invention were produced in the same manner as in Practical Example 6, except for the use of the rubber composition described in the previous paragraph.

### Practical Example 8

A rubber composition of the invention was prepared in the same manner as in Practical Example 6, except that, in accordance with the data of Table 2, the raw rubber material comprised a rubber blend composed of 122.5 parts by mass of the EPDM [EP98] (the product of JSR Co., Ltd.) (70 parts by mass of EPDM) and 30 parts by mass of a natural rubber (RSS-No. 1). This composition was used for preparing vibration-damping and vibration-isolating rubber products (vulcanized rubber sheets and specimens) of the invention.

### Practical Example 9

A rubber composition of the invention was prepared in the same manner as in Practical Example 6, except that, in accordance with the data of Table 2, the raw rubber material comprised a rubber blend composed of 140 parts by mass of the EPDM [EP98] (the product of JSR Co., Ltd.) (80 parts by mass of EPDM), 10 parts by mass of a styrene-butadiene rubber [JSR1500] (the product of JSR Co., Ltd.), and 10 parts by mass of a butadiene rubber [BR01] (the product of JSR Co., Ltd.). This composition was used for preparing vibration-damping and vibration-isolating rubber products (vulcanized rubber sheets and specimens) of the invention.

### Comparative Example 3

A comparative rubber composition was prepared in the same manner as in Practical Example 6, except that, in accordance with the data of Table 2, the silica was replaced by 30 parts by mass of FEF carbon black (SEAST-166”) (the product of Tokai Carbon Co., Ltd.) and that the specific silane coupling agent was not used at all. This comparative composition was used for preparing vibration-damping and vibration-isolating rubber products (vulcanized rubber sheets and specimens).

### Comparative Example 4

Comparative vibration-damping and vibration-isolating rubber products (vulcanized rubber sheets and specimens) were produced in the same manner as in Practical Example 6, with the exception that the specific silane coupling agent was replaced by 2 parts by mass of a silane coupling agent made from a bis-triethoxysilylpropyl polysulfide A-1589, the product of Nippon Unicar Co., Ltd.; an average sulfur number in the sulfur chain was 2).

[Workability and Storage Stability]

(1) Mooney Viscosity

The Mooney viscosity (125° C.) of all rubber compositions obtained in Practical Example 6 to 9 and Comparative Examples 3 and 4 was measured in accordance with JIS K 6300. The results of measurements are shown in Table 3 as an exponential factor referenced to the viscosity of the rubber composition of Comparative Example 3 as 100.

(2) Mooney Scorch Time

The Mooney scorch time (125° C.) of all rubber compositions obtained in Practical Example 6 to 9 and Comparative Examples 3 and 4 was measured in accordance with JIS K 6300. The results of measurements are shown in Table 3 as an exponential factor referenced to the viscosity of the rubber composition of Comparative Example 3 as 100.

(3) Tensile Strength and Elongation (General Physical Properties)

Specimens (dumbbell specimens #3) were produced from all 2 mm-thick vulcanized rubber sheets obtained in Practical Examples 6 to 9 and Comparative Examples 3 and 4. Tensile strength (TB) and elongation (EB) were measured in accordance with JIS K6251 at 25° C. and with a stretching speed of 500 mm/min. The results are shown in Table 3.

(4) Hardness

Hardness was measured on all 8 mm-thick vulcanized rubber sheets obtained in Practical Examples 6 to 9 and Comparative Examples 3 and 4 in accordance with JIS K 6253 (hardness by a JIS-A type hardness tester). The results of measurements are shown in Table 3.

(5) Static Spring Constant

Specimens (50 mm diameter x 25 mm thickness) obtained in Practical Examples 6 to 9 and Comparative Examples 3 and 4 were used for measuring the static spring constant in accordance with JIS K6385. More specifically, each specimen was compressed by 7 mm by a load applied in the axial direction of a cylinder, the load was reduced, and after the specimen restored its shape, it was compressed by 7 mm by a load for the second time, a load-deformation curve was plotted, and the static spring constant (Ks) was calculated from the loads in the 1.5 to 3.5 mm range of deformations on the curve. The results are shown in Table 3.

(6) Dynamic Spring Constant

Specimens (50 mm diameter×25 mm thickness) obtained in Practical Examples 6 to 9 and Comparative Examples 3 and 4 were used for measuring the dynamic spring constant in accordance with JIS K6385. More specifically, each specimen was compressed by 2.5 mm in the axial direction of a cylinder, and permanent-displacement harmonic compressive vibrations having the frequency of 100 Hz and amplitude of ±0.05 mm were applied from below the specimen to its center for determining 100 Hz dynamic spring constant (Kd₁₀₀). The results are shown in Table 3.

(7) Dynamic Multiplication Factor

The dynamic multiplication factor (the ratio of the dynamic spring constant to the static spring constant) was determined from the value of the dynamic spring constant (Kd₁₀₀) and the static spring constant (Ks) measured on the specimens obtained in Practical Examples 6 to 9 and Comparative Examples 3 and 4. The results are shown in Table 3.

(8) Compression Set

The compression set was measured on all specimens (diameter 29 mm×thickness 12.5 mm) obtained in Practical Examples 6 to 9 and Comparative Examples 3 and 4 in accordance with JIS K6262 and at the following conditions: temperature=100° C.; compression degree=25%; compression time=22 hours; and room-temperature relaxation time after compression=30 min. The results are shown in Table 3.

(9) Resistance to Ageing (Compression-Caused Permanent Deformation after Ageing)

This property was determined by measuring the compression set by the same method as in Item (8) above, but after the specimens obtained in Practical Examples 6 to 9 and Comparative Examples 3 and 4 (diameter 29 mm×thickness 12.5 mm) acquired heating hysteresis by heating for 24 hours at 150° C. in an oven and being held in a relaxation state at room temperature for 24 hours. The results are shown in Table 3.

TABLE 2

| | Practical | Practical | Practical | Practical | Comp. | Comp. |
|---|---|---|---|---|---|---|
| | Example | Example | Example | Example | Example | Example |
| | 6 | 7 | 8 | 9 | 3 | 4 |
| EPDM: “EP98”¹⁾ | 175 | 140 | 122.5 | 140 | 175 | 175 |
| (EPDM rubber | (100) | (80) | (70) | (80) | (100) | (100) |
| component) | | | | | | |
| EPM: “EP11”²⁾ | — | 20 | — | — | — | — |
| NR: “RSS-1” | — | — | 30 | — | — | — |
| SBR³⁾ | — | — | — | 10 | — | — |
| BR⁴⁾ | — | — | — | 10 | — | — |
| Silica⁵⁾ | 20 | 40 | 20 | 20 | — | 20 |
| FEF Carbon Black⁶⁾ | — | — | — | — | 30 | — |
| Specific Silane Coupling | 3 | 6 | 3 | 3 | — | — |
| Agent⁷⁾ | | | | | | |
| Silane Coupling Agent⁸⁾ | — | — | — | — | — | 2 |
| Softener: “PW-380”⁹⁾ | 5 | 5 | 5 | 5 | 5 | 5 |
| Zinc WhiteType1 | 5 | 5 | 5 | 5 | 5 | 5 |
| Stearic Acid | 1 | 1 | 1 | 1 | 1 | 1 |
| Anti-Aging Agent¹⁰⁾ | 1 | 1 | 1 | 1 | 1 | 1 |
| Sulfur | 2 | — | 2 | 2 | 2 | 2 |
| (Vulcanization Agent) | | | | | | |
| p-Quinonedioxime¹¹⁾ | — | 2.5 | — | — | — | — |
| Dicumylperoxide¹²⁾ | — | 8 | — | — | — | — |
| MBT¹³⁾ | 1 | — | 1 | 1 | 1 | 1 |
| CBS¹⁴⁾ | 1.5 | — | 1.5 | 1.5 | 1.5 | 1.5 |
| TMTD¹⁵⁾ | 0.7 | — | 0.7 | 0.7 | 0.7 | 0.7 |
| DPTT¹⁶⁾ | 0.5 | — | 0.5 | 0.5 | 0.5 | 0.5 |
| TeEDC¹⁷⁾ | 0.5 | — | 0.5 | 0.5 | 0.5 | 0.5 |

¹⁾“EPDM [EP98] (JSR Co., Ltd.) Oil-extended EPDM, oil component = 75 phr
²⁾“EPM [EP11] (JSR Co., Ltd.)
³⁾styrene butadiene rubber [JSR1500] (JSR Co., Ltd.)
⁴⁾butadiene rubber [BR01] (JSR Co., Ltd.)
⁵⁾silica “Nipsil ER” (Tosoh Silica Corporation)
⁶⁾“SEAST-166” (the product of Tokai Carbon Co., Ltd.)
⁷⁾3-octanoylthiopropyl trimethoxysilane [NXT silane] (the product of Nippon Unicar Co., Ltd.)
⁸⁾bis-triethoxysilylpropyl polysulfide “A-1589” (the product of Nippon Unicar Co., Ltd.)
⁹⁾petrochemical softener (Diana Process Oil PW-380, the product of Idemitsu Kosan Co., Ltd.)
¹⁰⁾2,2′-methylene-bis(4-ethyl-6-butylphenol) (Nonflex EBP, the product of Seiko Kagaku Co., Ltd.)
¹¹⁾vulcanization accelerator “VULNOC GM-P” (the product of Ouchishinko Chemical Industrial Co., Ltd.)
¹²⁾vulcanization accelerator “PERCUMYL D-40” (the product of Ouchishinko Chemical Industrial Co., Ltd.)
¹³⁾vulcanization accelerator prepared from 2-mercaptobenzothiazol (“Nocceler-M-P”) (the product of Ouchishinko Chemical Industrial Co., Ltd.).
¹⁴⁾vulcanization accelerator prepared from N-cyclohexyl-2-benzothiazol sulfenamide “Nocceler-CZ-G” (the product of Ouchishinko Chemical Industrial Co., Ltd.)
¹⁵⁾vulcanization accelerator prepared from tetramethylthiuram disulfide (“Nocceler-TT-P”) (the product of Ouchishinko Chemical Industrial Co., Ltd.).
¹⁶⁾vulcanization accelerator prepared from dipentamethylenethiuram tetrasulfide (“Nocceler-TRA”) (the product of Ouchishinko Chemical Industrial Co., Ltd.).
¹⁷⁾vulcanization accelerator prepared from diethyl dithiocarbamic acid tellurium (“Nocceler-TTTE”) (the product of Ouchishinko Chemical Industrial Co., Ltd.).

TABLE 3

| | | | | | Comp. | Comp. |
|---|---|---|---|---|---|---|
| | Practical | Practical | Practical | Practical | Example | Example |
| | Example 6 | Example 7 | Example 8 | Example 9 | 3 | 4 |
| Mooney Viscosity | 98 | 105 | 99 | 96 | 100 | 130 |
| [index number] | | | | | | |
| Mooney Scorch Time | 110 | 115 | 116 | 111 | 100 | 105 |
| [index number] | | | | | | |
| Tensile Strength (T_{B}) | 14.3 | 17.8 | 19.8 | 20.0 | 11.8 | 12.1 |
| [MPa] | | | | | | |
| Elongation (E_{B}) [%] | 450 | 430 | 410 | 420 | 370 | 380 |
| Hardness [JIS Type A] | 55 | 57 | 54 | 54 | 52 | 53 |
| Static Spring Constant | 461 | 461 | 411 | 390 | 390 | 412 |
| (Ks) [N/mm] | | | | | | |
| Dynamic Spring Constant | 641 | 636 | 555 | 530 | 694 | 709 |
| (Kd₁₀₀) [N/mm] | | | | | | |
| Dinamic Multiplication | 1.39 | 1.38 | 1.35 | 1.36 | 1.78 | 1.72 |
| Factor | | | | | | |
| Compression Set [%] | 18 | 15 | 26 | 22 | 26 | 25 |
| Compression Set [%] | 23 | 19 | 32 | 30 | 36 | 34 |
| after 150° C./24h ageing | | | | | | |

The following conclusions can be made by analyzing the results shown in Table 3.

(1) The rubber compositions obtained in Practical Examples 6 to 9 demonstrate low Mooney viscosity, are characterized by long Mooney scorch time, resist to scorching, and possess excellent workability and storage stability.

(2) The vulcanized rubbers obtained in Practical Examples 6 to 9 have a dynamic multiplication factor not exceeding 1.40 and are suitable for manufacturing vibration-damping and vibration-isolating rubber products.

(3) The vulcanized rubbers obtained in Practical Examples 6 to 9 have low compression set and have excellent properties required for vibration-damping and vibration-isolating rubber products.

(4) The vulcanized rubbers obtained in Practical Examples 6 to 9 have low compression set after ageing and have excellent characteristics (anti-ageing properties) required for vibration-damping and vibration-isolating rubber products.

(5) The vulcanized rubbers obtained in Practical Examples 6 to 9 have good general physical characteristics (tensile strength, elongation at rupture, and hardness).

(6) The rubber composition of Practical Example 6 that is compounded with the “NXT Silane” has lower Mooney viscosity and longer Mooney scorching time than the rubber composition of Comparative Example 4 compounded with “A-1589”.

(7) The vulcanized rubber of Practical Example 6 has a significantly lower dynamic multiplication factor than the vulcanized rubber of Comparative Example 4 (the former has a dynamic multiplication factor of 1.39, and the latter has a dynamic multiplication factor of 1.72).

(8) The vulcanized rubber of Practical Example 6 has lower compression set than the vulcanized rubber of Comparative Example 4 (the former has a compression set equal to 18 %, and the latter has compression set equal to 25%).

(9) The vulcanized rubber of Practical Example 6 has lower compression set after ageing than the vulcanized rubber of Comparative Example 4 (the former has a compression set after ageing equal to 23%, and the latter has compression set after ageing equal to 34%).

(10) The vulcanized rubber of Practical Example 6 has better general physical properties than the vulcanized rubber of Comparative Example 4.

(11) The rubber composition of Practical Example 6 that uses EPDM as a raw rubber material has lower Mooney viscosity than the rubber composition of Practical Example 1 that uses NR as a raw rubber material.

(12) The vulcanized rubber of Practical Example 6 has a significantly lower compression set than the vulcanized rubber of Practical Example 1 (the former has compression set of 18%, and the latter has compression set of 34%).

(13) The vulcanized rubber of Practical Example 6 has significantly lower compression set after ageing at 150° C. than the vulcanized rubber of Practical Example 1 (the former has a compression set after ageing at 150° C. equal to 23%, and the latter has compression set after ageing at 150° C. equal to 78%).

(14) By increasing the percentage of EPDM in the raw rubber material, it becomes possible to reduce compression set (results of the rubber compositions obtained in Practical Examples 6, 8, and 9).

(15) By increasing the percentage of EPDM in the raw rubber material, it becomes possible to reduce compression set after ageing (results of the rubber compositions obtained in Practical Examples 6, 8, and 9).

### INDUSTRIAL APPLICABILITY

The vibration-damping and vibration-isolating rubber of the invention (vulcanized rubber obtained from the rubber composition of the invention) is suitable for use in products intended to reduce vibration energy in such fields as building and bridge structures, industrial machines, means of transportation, etc.

The vibration damping and vibration-isolating rubber products of the invention containing natural rubber (NR) in the raw rubber material are most suitable for applications that require low the dynamic multiplication factor.

The vibration-damping and vibration-isolating rubber products of the invention containing EPM and/or EPDM in the raw rubber material are most suitable for applications that require high anti-ageing properties and reduced compression set.

1. A vibration-damping and vibration-isolating rubber composition comprising: 100 parts by mass of a raw rubber material having C—C bonds in the main chain; 1 to 200 parts by mass of silica; and a silane coupling agent represented by the following formula (1): Y₃—Si-Z-S—CO—R where Y is an acetoxy or alkoxy group with 1 to 6 carbon atoms, Z is an alkylene group with 1 to 8 carbon atoms, and R is a hydrocarbon group with 1 to 18 carbon atoms in the amount of 2 to 40 mass % per total amount of the silica.

2. The vibration-damping and vibration-isolating rubber composition of claim 1, wherein said raw rubber material is selected from the group consisting of a natural rubber (NR), styrene butadiene rubber (SBR), isoprene rubber (IR), butadiene rubber (BR), butyl rubber (IIR), halogenated butyl rubber (X-IIR), chloroprene rubber (CR), acrylonitrile butadiene rubber (NBR), a copolymer of ethylene and propylene (EPM), a terpolymer of ethylene, propylene, and a diene (EPDM).

3. The vibration-damping and vibration-isolating rubber composition of claim 1, wherein said silane coupling agent is selected from the group consisting of a 3-triethoxysilylpropyl thioacetate, 3-trimethoxysilylpropyl thioacetate, 3-octanoylthiopropyl trimethoxysilane, 3-octanoylthiopropyl trimethoxysilane, 3-octanoylthiopropyl tripropoxysilane, 2-acetylthioethyl trimethoxysilane.

4. The vibration-damping and vibration-isolating rubber composition of claim 1, wherein said raw rubber material comprises 20 to 100 parts by mass of a natural rubber and 80 to 0 parts by mass of a synthetic rubber.

5. The vibration-damping and vibration-isolating rubber composition of claim 1, wherein said raw rubber material contains 30 to 100 mass % of an ethylene-propylene rubber (EPM) and/or ethylene-propylene-diene rubber (EPDM).

6. The vibration-damping and vibration-isolating rubber composition of claim 1, wherein a dynamic multiplication factor after vulcanization does not exceed 1.40.

7. A method of preparing a vibration-damping and vibration-isolating rubber composition by mixing and kneading:
(A) 100 parts by mass of a raw rubber material having C—C bonds in the main chain;
(B) 5 to 200 parts by mass of silica; and
(C) a silane coupling agent represented by the following general formula (1): Y₃—Si-Z-S—CO—R where Y is an acetoxy or alkoxy group with 1 to 6 carbon atoms, Z is an alkylene group with 1 to 8 carbon atoms, and R is a hydrocarbon group with 1 to 18 carbon atoms in the amount of 2 to 40 mass % per total amount of the silica.

8. The method of preparing a vibration-damping and vibration-isolating rubber composition of claim 7, wherein said raw rubber material comprises 20 to 100 parts by mass of a natural rubber and 80 to 0 parts by mass of a synthetic rubber.

9. The method of preparing a vibration-damping and vibration-isolating rubber composition of claim 7, wherein said raw rubber material contains 30 to 100 mass % of an ethylene-propylene rubber (EPM) and/or ethylene-propylene-diene rubber (EPDM).

10. A product of a vibration-damping and vibration-isolating rubber obtained by vulcanizing the rubber composition of claim 1.

11. A product of a vibration-damping and vibration-isolating rubber obtained by vulcanizing the rubber composition of claim 4.

12. A product of a vibration-damping and vibration-isolating rubber obtained by vulcanizing the rubber composition of claim 5.

13. A product of a vibration-damping and vibration-isolating rubber obtained by vulcanizing the rubber composition of claim 6 and having a dynamic multiplication factor not exceeding 1.4.

14. A method of manufacturing a product of a vibration-damping and vibration-isolating rubber by vulcanizing the rubber composition of claim 1.

15. The vibration-damping and vibration-isolating rubber composition of claim 2, wherein a dynamic multiplication factor after vulcanization does not exceed 1.40.

16. The vibration-damping and vibration-isolating rubber composition of claim 3, wherein a dynamic multiplication factor after vulcanization does not exceed 1.40.

17. The vibration-damping and vibration-isolating rubber composition of claim 4, wherein a dynamic multiplication factor after vulcanization does not exceed 1.40.

18. The vibration-damping and vibration-isolating rubber composition of claim 5, wherein a dynamic multiplication factor after vulcanization does not exceed 1.40.

19. A method of manufacturing a product of a vibration-damping and vibration-isolating rubber by vulcanizing the rubber composition of claim 4.

20. A method of manufacturing a product of a vibration-damping and vibration-isolating rubber by vulcanizing the rubber composition of claim 5.
